(19) United States
(12) Patent Application Publication
(10) Pub. No.: US 2010/0055245 A1
(43) Pub. Date: Mar. 4, 2010

(54) Modifying Flavor Experience Via Aroma Delivery

(75) Inventors: Margaret Havekotte, Fairfield, CT (US); Marco Covarrubias, White Plains, NY (US)

Correspondence Address: BANNER & WITCOFF, LTD.;and ATTORNEYS FOR CLIENT NO. 006943, 10 SOUTH WACKER DR., SUITE 3000, CHICAGO, IL, 60606, US

(73) Assignee: PepsiCo, Inc., Purchase, NY (US)

(21) Appl. No.: 12/548,549

(22) Filed: Aug. 27, 2009

Related U.S. Application Data
(60) Provisional application No. 61/093,769, filed on Sep. 3, 2008.

(51) Int. Cl. A23L 2/56; A23L 2/52; A23L 2/00; B65D 85/72; B65D 85/80

(52) U.S. Cl. 426/66; 426/392; 426/536; 426/535; 426/106; 426/130

(57) ABSTRACT

A method for modifying flavor experience via aroma delivery including applying at least one aroma on a comestible's packaging, the aroma causing the consumer to perceive a modified flavor of the comestible upon ingestion of the comestible. The comestible may be a beverage, such as a carbonated soft drink, fruit juice, water or grain-based beverage.

### FIELD OF THE INVENTION

The present invention relates generally to a method for modifying flavor experience via aroma delivery. More particularly, the present invention relates to a method of applying an aroma to a comestible's packaging and releasing such aroma to modify the aroma, flavor and/or taste experienced by a consumer, and the comestible product with modified attributes.

### BACKGROUND

The taste experienced and/or perceived by an individual upon consumption of a comestible is influenced by many factors. For instance, taste may vary depending on the ingredients added to the product, processing techniques used, and the smell of the product.

Although others have found various ways to provide consumers with products with modified tastes and/or flavors, the modifications usually require the addition of an ingredient(s) or compound(s) to the product, which in turn alters the composition of the product, resulting in a need for the manufacturer to reformulate the product. Such reformulation results in added cost to the manufacturer. Additionally, the magnitude and character of the aroma experience may be influenced by factors such as the partitioning or solubility of aroma components, limiting the formulation and the resultant consumer experience. Modifying the taste of a comestible without altering the composition of the comestible is advantageous for a variety of reasons, in addition to alleviating the need to reformulate, there is no concern that an added ingredient will react unfavorably with the existing ingredients in the product, and there is no need to re-label the product.

The applicant discovered that releasing an aroma in the air prior to and/or while a person is consuming a comestible, affects the consumer's perceived taste of the comestible. Moreover, certain aromas can be used to counteract, enhance, or modify certain properties affecting the taste and/or flavor of the comestible, including freshness, off-notes, bitterness, sourness and/or sweetness. Although the primary benefit of the present invention is to enhance aroma, additional benefits may also include learned cues such as freshness and quality associated with aroma that can lead to consumer likability of the comestible, in addition to taste modulation.

Since obesity, high blood pressure and high cholesterol are health concerns for many individuals, there exists a need for a healthy alternative to the higher calorie/sugar products. At least one application of the method and comestible product of the present invention includes applying an aroma to a package to alter the consumer's perceived sweetness of the comestible; therefore, less sugar can be added to the comestible, resulting in a healthier alternative for the weight/calorie-conscious consumer. The present invention may also be used to mask, modify or reduce off-notes, off-aromas, or off-taste and other undesirable characteristics imparted to the comestible during processing, cooking, or the like. Moreover, the present invention can also modify positive aromas and/or modulate positive tastes.

There are many ways to adhere an aroma to a product's packaging, for example by using the technology described in U.S. Pat. No. 5,249,676 and U.S. Pat. No. 5,281,471. Additional means to adhere the product to the package include those described in U.S. Pat. No. 6,102,224.

### BRIEF SUMMARY

The present invention relates to a method for modifying flavor experience via aroma delivery. In one aspect of the present invention, aroma is applied to the outside of the packaging of a beverage. The aroma is released into the atmosphere and is presented to the consumer prior to consuming the beverage. The delivery of the aroma via orthonasal and/or retronasal routes causes a gustatory response, a physiological, and/or a psychological response from learned experiences with the aroma, altering the consumer's perceived taste of the beverage.

### DETAILED DESCRIPTION OF THE INVENTION

The present invention relates to comestible products. In particular, the present invention relates to a method for producing a comestible with perceived enhanced attributes without altering the composition of the product, and the product displaying these enhanced attributes. “Modified attributes” may relate to taste and/or aroma and means reducing bitterness, sourness, enhancing sweetness, aroma enhancement, freshness, or modifying other properties of a comestible. “Aroma” means a substance containing an odor and capable of being released into the atmosphere. “Comestible” as used herein means any edible product, including beverages.

Aroma delivered orthonasally and/or retronasally affects flavor experience. The flavor or aroma used in the present invention may be delivered to the consumer via orthonasal and/or retronasal routes. The olfactory interactions trigger a gustatory and/or somatosensory response causing the consumer to perceive a modified flavor or taste. More specifically, the aroma volatile compounds delivered prior to consuming the comestible enhance the flavor experience while the consumer is ingesting the comestible. Secondarily, the experience or associations that have been learned by the consumer may also influence the flavor experience. In particular, the aroma delivered to the consumer in accordance with the present invention may trigger learned experiences or associations between the aroma and the associated comestible. The delivery of the aroma in accordance with the present invention may cause a psychological response from the consumer's learned experiences with the composition, thereby altering the consumer's perceived taste of the comestible.

In one aspect of the present invention, the aroma applied to the comestible's packaging and/or added to the comestible does not alter the composition of the product. Additionally, upon ingestion, the aroma used in the instant invention does not alter the composition of the comestible inside the consumer's mouth.

Aroma. The aromas that may be used in accordance with the present invention include, but are not limited to natural and artificial aromas such as lemon, vanilla, vanillin, orange (e.g., orange oil), cola, lime, berry, coffee, citrus (e.g., citrus oil), spice, sugary, perfumes, maltol, furaneol, citrus oils, aldehydes, esters, alcohols, terpenes, sesquiterpenes, sulfur compounds, and combinations thereof. Such aromas may be GRAS or non-GRAS. The concentrations of the aromas that may be applied to the comestible's packaging vary depending on the aroma used. For instance, the aroma concentration may range from implicit (i.e., below noticeable concentration) to explicit (i.e., at a noticeable concentration). More specifically, the concentration of an aroma used in accordance with the present invention may range from about 0.003 gram to about 0.1 gram of aroma per gram of packaging (wt. aroma/wt packaging). Moreover, the aroma delivered via the present invention may be the sole source of aroma, or may be a secondary source of aroma to the aroma(s) already existing in the product. The aromas that may be used in conjunction with the present invention may impact physiological processes and may be used for purposes of stress reduction, relaxation, mood, and/or performance enhancement, in addition to refreshment enhancement.

Comestible. The comestible used in the present invention may be a food, beverage, chewing gum, or other edible product. The beverages that may be used include, but are not limited to carbonated soft drinks, water, fruit juices, coffee and coffee-based beverages, non-carbonated soft drinks, isotonic beverages and dairy-based beverages. Foods that may be used include, but are not limited to oatmeal, cereals, snack foods (salty and sweet snacks), bars and soups.

Sweet enhancement. In accordance with the present invention, the sweetness of a comestible is enhanced by applying an aroma to the product's packaging. One of the advantages of such sweetness enhancement includes brix reduction (i.e., reduction of the amount of sugar in the comestible). For example, by applying a sweet aroma, such as furaneol, vanillin, maltol, sugar distillate, or a mixture of these aromas to the packaging of a carbonated soft drink, the manufacturer can reduce the amount of sugar traditionally added to a “full calorie” carbonated soft drink (i.e., not a diet or light beverage). This reduction in sugar can result in weight management/health and wellness benefits to the consumer, as he is ingesting fewer calories while at the same time experiencing a taste similar to that of a higher-calorie/sugar comestible. Using a headspace aroma with a beverage to enhance its overall perceived sweetness intensity offers beverage manufacturers the ability to optimize taste attributes of its beverage(s) with reduced sugar/sweetener levels.

Mask and reduce off-notes. Oftentimes when foods and beverages are processed using techniques such as pasteurization, steaming, heating, cooking, etc. such processing can give rise to off-notes in a comestible. Moreover, other factors such as age, environmental stress on products, and packaging materials can also influence and create off-notes. The off-notes can be aroma and/or taste off-notes. In another aspect of the present invention, the aroma and/or flavor applied to the comestible's packaging can be used to mask or reduce certain off-notes associated with a comestible. For example, citrus oil, such as orange oil applied to the packaging of orange juice delivers freshness, masks cooked off-notes, and imparts sweetness to the juice; whereas vanillin applied to the packaging of a hot-fill dairy product will mask milk off-notes in the hot-fill dairy product, such that when the vanillin is released into the air and presented to the consumer, he tastes a hot-fill dairy product with reduced and/or no off-notes.

Bitter reduction. In another aspect of the present invention, the aroma may be applied to the comestible's packaging to reduce or eliminate the consumer's perceived bitterness of the comestible. For example, beverages such as citrus juices may have a bitter taste and/or bitter off-notes due to processing procedures such as pasteurization or retorting. By placing citrus oil, such as orange oil, on the packaging of the orange juice product, and following release of the aroma to the air, the aroma is presented to the consumer, causing the consumer to perceive an orange juice product with reduced bitterness.

Freshness (“true to fruit character”). In yet another aspect of the present invention, the method can be used to deliver an aroma to the consumer, causing the consumer to perceive freshness and/or improved freshness of the comestible upon ingesting the comestible. For instance, a lemon aroma may be applied to the comestible's packaging, after such aroma is released into the air, such aroma is presented via the orthonasal or retronasal route to the consumer, resulting in the consumer perceiving the comestible to have enhanced freshness, or more “true to fruit” characteristics. It was also found that the aroma delivered in accordance with the present invention may cue freshness which in turn cues quality. The combination of positive cues produces a “halo effect” leading to the consumer's overall liking of the product. The Applicants further discovered that quality cues not only infer “good” quality, but also may trigger an emotional linkage between the aroma and a comestible. This linkage is based on memory and experiences associated with the aroma. For example, the fresh smelling attributes of orange juice can trigger emotions and memories of special times and places, such as fond childhood memories associated with the aroma, thereby leading to consumer acceptability of the beverage as a result of this aroma-emotion linkage.

Overall aroma enhancement. Another aspect of the instant invention includes using the method described herein for overall aroma enhancement of the comestible. For instance, in accordance with the present invention, a lemon-lime aroma is applied to the packaging of the beverage. Upon releasing the aroma prior to drinking, the consumer perceives a stronger/more intense lemon-lime flavor while drinking the beverage.

Packaging. Various techniques for applying the aroma to the packaging may be used in accordance with the present invention. For instance, the aroma can be sprayed onto or into the packaging, a film or cover may be lifted off of a strip or reservoir containing the aroma, or some other friction-released mechanism may also be used. Friction is one of many release mechanisms for aroma delivery, and the aroma may also be delivered/released by mechanisms including, but not limited to compartments and chemical reactions. The aroma may be added to the inside, outside, or both on the inside and outside of the product's packaging. One of ordinary skill in the art would recognize that a cap or other removable portion of the package is part of the comestible's packaging. One of ordinary skill in the art would also recognize that any packaging or addition/extension to the packaging that includes a reservoir to house the aroma and a way to release it into the atmosphere could be used in accordance with the present invention. The aroma may also be placed directly into or onto the comestible. Examples of packaging that may be used in accordance with the present invention include, but are not limited to bottles (plastic and glass), cans, plastic or paper bags, caps, closures, straws, cardboard boxes and coatings thereto.

In accordance with one aspect of the present invention, aroma may be applied to the closure in trace amounts (i.e., parts per trillion) or more significant amounts (i.e., grams) depending on the aroma character and potency of the aroma being used. For instance, about 0.009 g of orange aroma or 0.003 g of coffee aroma is applied to a closure. The closure is then affixed to a single serve container of a beverage, for example, orange juice. Prior to consumption, the consumer twists off the cap of the beverage. The twisting action creates friction, thereby releasing the aroma into the atmosphere. The aroma released from the cap causes an aroma-taste interaction within the consumer thereby altering the perceived taste of the beverage. One of ordinary skill in the art of the food sciences would appreciate that the concentration of aroma varies depending on the types of flavors added and such concentrations may even vary by the vendor and quality of the flavor.

The packaging described in this application can be packaging for single-serve or multi-serve containers. As one of ordinary skill in the art of food sciences would appreciate, the aroma concentration used in accordance with the present invention may be adjusted based on the serving size. It was also discovered that variations in the aroma concentration can affect not only aroma-taste interactions in the immediate vicinity of the user (i.e., under the user's nose while consuming the product), but also about 1-5 feet, for instance about 1-3 feet from the product containing the aroma.

The aroma compounds used in the present invention may be polar, non-polar, or a mixture thereof. Moreover, these compounds may include organic molecules, inorganic molecules or a mixture thereof. Polar and/or non-polar aroma compounds or molecules may be used in conjunction with the method and comestible product(s) of the present invention. Such aroma compounds may be also be encapsulated and subsequently applied to the comestible's packaging. For example, encapsulation of aromas such as coffee and lemon in products such as waters and acidic beverages exhibit enhanced stability compared to the stability of these aromas when directly added to the product and/or incorporation into the product matrix. For example, the key aroma compound in lemon oil when placed into a beverage loses over 90% of its aroma concentration after five weeks. However, lemon oil when encapsulated and applied to the outside of a bottle remains stable at 90° F. for at least three months.

As described, the present invention provides a method for modifying flavor experience via aroma delivery. An example of one aspect of the present invention is as follows:

A new aroma-focused packaging/product innovation for orange juice was developed to enhance the overall product experience. It was discovered that the aroma experience was enhanced which compensated for the fresh orange juice characteristics lost during processing. In addition taste perception was enhanced through aroma-taste interaction.

Consumer testing was performed as follows:

Each respondent was served one control (current shelf-stable orange juice product) and one test sample.

Test samples consisted of chilled shelf-stable juice (current orange juice product) poured into 10 oz glass bottle and capped prior to serving. Encapsulated aromas were pre-applied to the cap prior to the testing. The aroma enhancement was released by friction upon opening the beverage (i.e., twisting open the cap).

Respondents were asked to drink at least a third of each product with a bite of cracker and a sip of water before tasting each sample.

Following evaluation by respondents, it was found that the test product was significantly preferred compared to the control. The test sample delivered significantly less aftertaste, more fresh taste, more natural taste and improved sweet quality along with overall/strength of flavor. Additionally, the test product was judged by the consumers to be significantly fresher, healthier, more natural, hand-squeezed, higher quality and energizing compared to the control product.

This invention may be embodied in other specific forms without departing from the spirit or essential characteristics thereof. The foregoing embodiments, therefore, are to be considered in all respects illustrative rather than limiting the invention described herein. The scope of the invention is thus indicated by the appended claims, rather than by the foregoing description, and all changes that come within the meaning and range of equivalency of the claims are intended to be embraced therein.

We claim:

1. A method for modifying the flavor experience associated with a comestible via aroma delivery comprising the steps of:
a. applying at least one aroma on a package of a comestible, such aroma to modify a consumer's taste experience and capable of being released into the atmosphere; and
b. providing a consumer with the comestible having at least one modified attribute as a result of the interaction between the aroma and the consumer's perceived taste of the comestible.

2. The method of claim 1 wherein the comestible is a beverage, wherein the at least one modified attribute is reduced calories, and the at least one aroma is selected from the group consisting of furaneol, vanillin, maltol, sugar distillate and combinations thereof.

3. The method of claim 1 wherein the aroma is selected from the group consisting of lemon, vanilla, vanillin, orange, cola, lime, berry, coffee, citrus, spice, sugary, perfumes, maltol, furaneol, orange oil, citrus oils, aldehydes, esters, alcohols, terpenes, sesquiterpenes, sulfur compounds, and combinations thereof.

4. The method of claim 1 wherein the at least one aroma is applied to the outside of the package.

5. The method of claim 1 wherein the at least one aroma is applied to the inside of the package.

6. The method of claim 1 wherein the at least one modified attribute is increased sweetness.

7. The method of claim 1 wherein the at least one modified attribute is reduced bitterness.

8. The method of claim 1 wherein the at least one modified attribute is masking off-notes.

9. The method of claim 1 wherein the comestible is selected from the group consisting of carbonated drinks, water, fruit juices, coffee-based beverages and dairy-based beverages.

10. A method for modifying the flavor experience associated with a comestible via aroma delivery comprising the steps of:
a. applying at least one aroma to the surface of a package containing a comestible, the aroma capable of being released into the atmosphere; and
b. releasing the at least one aroma to the atmosphere such that upon ingesting the comestible a consumer perceives a modified taste in the comestible.

11. The method of claim 10 wherein the modified taste is selected from the group consisting of bitterness reduction, masking off-notes and increased sweetness.

12. The method of claim 10 wherein the at least one aroma is selected from the group consisting of lemon, vanilla, vanillin, orange, cola, lime, berry, coffee, citrus, spice, sugary, perfumes, maltol, furaneol, orange oil, citrus oils, aldehydes, esters, alcohols, terpenes, sesquiterpenes, sulfur compounds, and combinations thereof.

13. The method of claim 10 wherein the at least one aroma is applied to the outside of the package in contact with a closure of the package, wherein the at least one aroma is released upon removal of the closure.

14. A comestible comprising:
a. a package at least partially housing the comestible; and
b. at least one aroma affixed to the packaging, the at least one aroma is capable of being released into the atmosphere; wherein upon the at least one aroma being released into the atmosphere and the comestible being ingested, a consumer perceives a modified taste in the comestible.

15. The comestible of claim 14 wherein the at least one aroma is released before drinking.

16. The comestible of claim 14 wherein the at least one aroma is released during drinking.

17. The comestible of claim 14 wherein the at least one aroma is selected from the group consisting of lemon, vanilla, vanillin, orange, cola, lime, berry, coffee, citrus, spice, sugary, perfumes, maltol, furaneol, orange oil, citrus oils, aldehydes, esters, alcohols, terpenes, sesquiterpenes, sulfur compounds, and combinations thereof.

18. The comestible of claim 14 wherein the comestible is a beverage.

19. The comestible of claim 18 wherein the beverage is selected from the group consisting of carbonated drinks, water, fruit juices, coffee-based beverages and dairy-based beverages.

20. The comestible of claim 14 wherein the at least one aroma is affixed to the outside of the packaging.

21. The comestible of claim 14 wherein the at least one aroma is applied to the outside of the package in contact with a closure of the package wherein the at least one aroma is released upon removal of the closure.
